(19) United States
(12) Patent Application Publication
(10) Pub. No.: US 2004/0252001 A1
(43) Pub. Date: Dec. 16, 2004

(54) INSULATOR FOR ARMATURE

(75) Inventors: Takashi Yamada, Mori-machi (JP); Hisanobu Higashi, Mori-machi (JP); Susumu Ando, Mori-machi (JP)

Correspondence Address: ERNEST A. BEUTLER, ATTORNEY AT LAW, 10 RUE MARSEILLE, NEWPORT BEACH, CA, 92660, US

(73) Assignee: KABUSHIKI KAISHA MORIC, Mori-machi (US)

(21) Appl. No.: 10/709,919

(22) Filed: Jun. 5, 2004

(30) Foreign Application Priority Data
Jun. 10, 2003 (JP) 2003-164463

(51) Int. Cl. H01F 27/30

(52) U.S. Cl. 336/198

(57) ABSTRACT

Several embodiments of insulating bobbin halves for an armature core that facilitate assembly while maintaining good pole teeth coverage.

### BACKGROUND OF INVENTION

This invention relates to an insulator for the armature of a rotating electrical machine and more particularly to an improved insulator construction that facilitates assembly to the armature core.

It is well known to provide an insulating bobbin assembly that surrounds and insulates the coil windings surrounding the magnetic pole teeth. Generally these bobbins are provided in pairs with each half embracing a portion of the facing surfaces of the pole teeth in the slots therebetween. In order to facilitate assembly it has been proposed to taper the facing ends of the of the insulator side surfaces in engagement with the facing pole tooth surfaces as shown, for example, in published Japanese application, publication number 2003-88029 (A). However even though this is done, the remaining legs are straight and may hinder the assembly. In addition too much of the pole tooth may be exposed.

Therefore it is a principal object of this invention to provide an insulator for the armature of a rotary electrical machine that is easier to assemble and which minimizes the amount of exposed pole teeth.

### SUMMARY OF INVENTION

This invention is adapted to be embodied in an insulator for the coil windings of an armature for a rotating electrical machine. The armature has a core having a cylindrical portion from which a plurality of circumferentially spaced teeth extend in a radial direction relative to the axis of relative rotation of the machine and defining slots therebetween. The insulator has a plurality of circumferentially spaced extensions having at least three sides. Two of the sides are adapted to extend radially along the facing surfaces of adjacent of the teeth. The remaining side comprising an interconnecting side extending between common peripheral ends of the two sides and is adapted to be disposed at one end of the slot between the adjacent teeth. The projected ends of the sides tapering from at least one peak of the maximum length of the sides in the axial direction for facilitating fitting of the insulator into the armature in the slot in an axial direction.

### BRIEF DESCRIPTION OF DRAWINGS

FIG. 1 is an exploded, perspective view of an electrical armature constructed in accordance with the invention.

FIG. 2 is an enlarged perspective view looking in the same direction as FIG. 1 but showing only the top insulator half.

FIG. 3 Is a top plan view of the insulator half shown in FIG. 2.

FIG. 4 is a bottom plan view of this insulator half.

FIG. 5 is a partial, further enlarged view looking in the same direction as FIG. 2.

FIG. 6 is circumferential developed view of an insulator half showing one embodiment.

FIG. 7 is circumferential developed view, in part similar to FIG. 7, but showing how two insulator haves are related in accordance with an embodiment of the invention.

FIG. 8 is a circumferential developed view showing both insulator halves in accordance with this embodiment.

FIG. 9 is an enlarged cross sectional view taken along the line 9-9 of FIG. 8.

FIG. 10 is a circumferential developed view in part similar to FIG. 7 showing both insulator halves in accordance with yet another embodiment.

FIG. 11 is a circumferential developed view, in part similar to FIG. 8, but showing both insulator halves in accordance with this embodiment FIG. 12 is an enlarged cross sectional view, in part similar to FIG. 9, but taken along the line 12-12 of FIG. 11.

FIG. 13 is a circumferential developed view in part similar to FIGS. 7 and 10 showing both insulator halves in accordance with still another embodiment.

FIG. 14 is a circumferential developed view, in part similar to FIGS. 8 and 11, but showing both insulator halves in accordance with this embodiment.

FIG. 15 is an enlarged cross sectional view, in part similar to FIGS. 9 and 12, but taken along the line 15-15 of FIG. 14.

### DETAILED DESCRIPTION

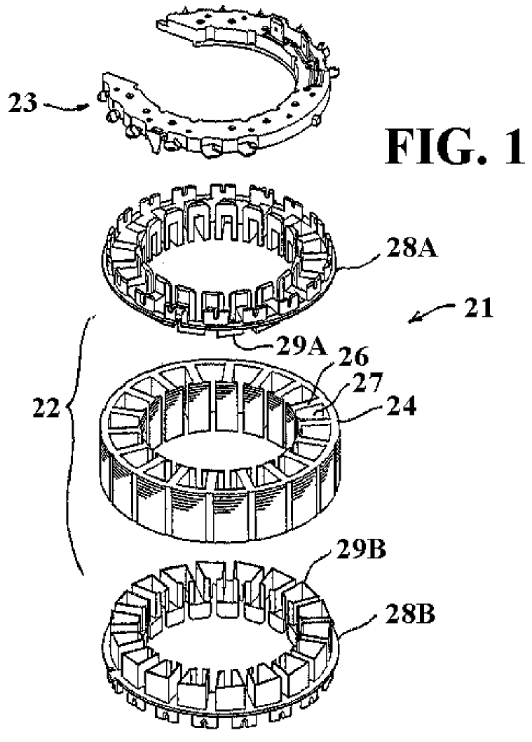

Referring now in detail to the drawings and initially to FIG. 1 an armature with an insulator as a component according to this invention is indicated generally at 21. The armature 21 according to the illustrated embodiment is provided for a three-phase motor is comprised of in this embodiment a stator, indicated generally at 22, and a wiring base 23 attached to one axial end (top end side in FIG. 1) of the stator 22 in a manner to be described.

The stator 22 is made up of a ferromagnetic stator yoke 24 comprised of a body of laminated thin plates, The stator yoke 24 is formed generally into a ring shape so as to surround the periphery of a rotor (not shown). This is comprised of a circumferential portion 25 from which a plurality of integral magnetic pole teeth 26 projecting radially inward and which in this embodiment are equally circumferentially spaced. Slots 27 are formed between every two adjacent magnetic pole teeth 26.

Fixed in a manner to be described to opposite sides of the core 24 are upper and lower, insulating bobbin halves, indicated generally as 28A and 28B, respectively. Insert portions or insert lugs, indicated generally at 29A and 29B, formed in the same number as the slots integrally with side of the ring-like insulating bobbin halves 28A and 28B facing the stator core 24. These insert portions or insert lugs 29A and 29B are inserted from above and from under into the slots 27, so that both insulators 28A and 28B are circumferentially secured and held to the stator yoke 24.

Coils (not shown) are wound around the upper and lower insulators 28A and 28B, and the pole teeth 26 of the stator yoke 24 in any desired manner. The ends of these coils are suitably connected to the wiring plate 23.

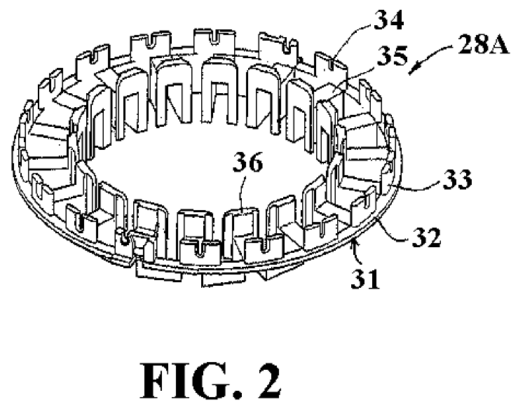

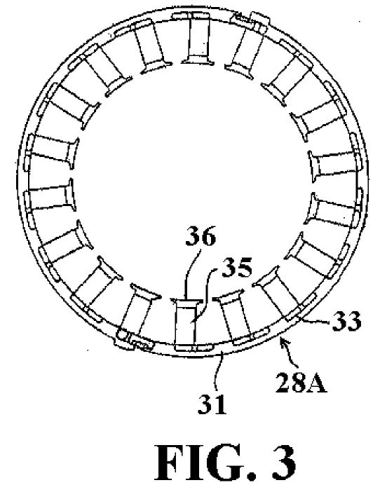

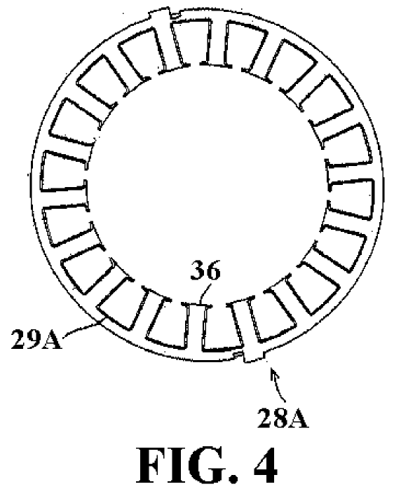

Since, except for the shapes of the lugs 29A and 29B the insulating bobbin halves 28A and 28B, are the same, their construction will generally be described by reference to FIGS. 2-4, initially. Each insulating bobbin half 28A and 28B is has a ring shape outer surface 3l complimentary to the yoke portion 25 so as to surround the round surface of the associated rotor (not shown). An outer surface 32 of the ring-like base 31 is formed with a large number of winding receivers 33 arranged at spaced circumferential positions for engaging and holding the coil winding ends. Each winding receiver 33 is formed with a cut 34 through which a winding end is drawn radially out of the insulating bobbin half 28A and 28B.

The insulating bobbin halves 28A and 28Bare also provided with plural coil end carrier portions 35 projecting radially inward and integrally from parts of the insulating bobbin halves 28A and 28B where the winding receivers 33 are formed. The coil end carrier portions 35 engage with the magnetic pole teeth 26 of the stator yoke 24 and cover the coil end faces located on the side of the magnetic pole teeth 26, with the spaces between every two circumferentially adjacent coil end carrier portions 35 corresponds to the slots 27 of the stator yoke 24. Therefore, every insert portion 29A and 29B (FIG. 1) described before is formed in a position that is below and between every two adjacent coil end carrier portions 35.

Flanges 36 for supporting the inner round ends of the coils are formed integrally on the radially inner sides of the coil end carrier portions 35. The flanges 36 receive coil ends (not shown) with the inside round portion of the stator 22. Incidentally, the term, coil end, is used in relation to the coil wound up and down around each magnetic pole tooth 26 through the slots 27 (FIG. 1) to refer to those parts of the coil which bulge up and down from the slot 27, or the parts which are turned over at the top and bottom (turned-over portions). The coil end is supported, on its radially inner side, with the flanges 36 of the upper and lower insulators 28A and 28B, and on its radially outer side, by the winding receivers 33.

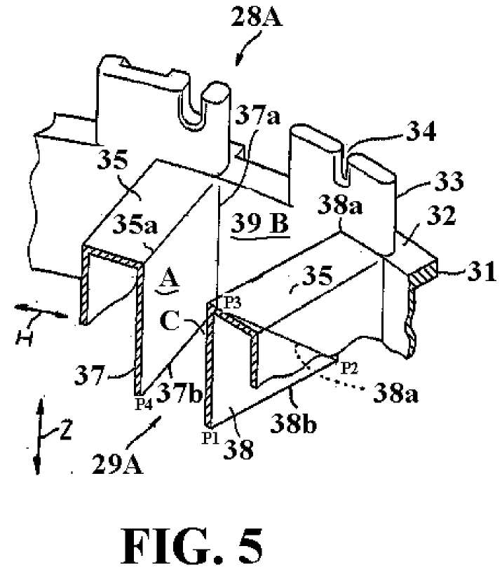

The construction of the insert portions 29A and 29B of this invention will now be described by initial reference to FIG. 5. In order for its construction to be understood more easily, the flange 36 removed in this figure. In accordance with the invention, the insert portions associated with adjacent pairs of pole teeth 26 are comprised of three sides comprised of a pair of facing sides 37 and 38, each of which at least covers a portion of the facing surfaces of the teeth 26. These are comprised of a first side wall 37 (surface A) formed integrally with one coil end carrier portion 35 (left-hand side in FIG. 5) that extends in the axial direction of the insulating bobbin half 28A from the top side, the end edge 35a, of the coil end carrier portion 35; a second side wall 38 (surface C) formed integrally with another coil end carrier portion 35 (right-hand side in FIG. 5) that extends in the axial direction of the insulating bobbin half 28A from the top side, the end edge 35a, of this coil end carrier portion 35; and an interconnecting third side wall 39 (surface B) located between the first side wall 37 and the second side wall 38 with its ends connected to the radially outside end edges 37a and 38a of the first side wall 37 and the second side wall 38.

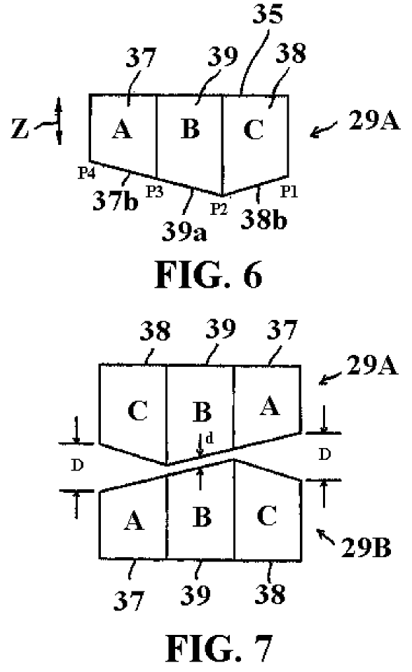

The first side wall (surface A) 37, the second side wall (surface C) 38, and the third side wall (surface B) 39 are formed integral with the inside of the ring-like base 31 of the insulating bobbin halves 28A and 28B. For convenience in explanation and as already noted, the inside wall surface of the first side wall 37 is referred to as the surface A, the inside wall surface of the second side wall 38 is referred to as the surface C, and the inside wall surface of the third side wall 39 is referred to as the surface B. The corners of the tips of the insert portion of the generally U shape are formed with the end edges 37b, 38b, and 39a of the side walls 37, 38, and 39 are indicated in FIGS. 5 and 6 respectively by P1, P2, P3, and P4 in the order from the surface C side.

In accordance with the invention the bottom edges 37b, 38b, and 39a of the side walls 37, 38, and 39 are configured so that they have no parts that extend perpendicularly to the direction of their insertion into the slots 27 in the core 24. In that way the smooth insertion is facilitated. Basically these bottom edges taper from one or more peaks of maximum length as may be best understood from the following descriptions referring to several circumferential developed views where the edges 37b, 38b, and 39a of are folded to lie in a common plane. Referring first to the embodiment of FIG. 6, it will be seen that the three side walls 37, 38, and 39 (or the surface A, surface C, and surface B) are all formed as trapezoids. When the corners P1, P2, P3, and P4 are compared with each other, it will be seen that the corner P2 is a leading tip, the corners P1 and P3 are approximately the same in height, and the corner P4 is farthest from the corner P2 in the axial direction is the nearest in height to the coil end carrier portion 35. Incidentally, the above “side wall dimension in the axial direction of the insulating bobbin half” refers to the straight line distance in this figure from the coil end carrier portion 35 to the bottom sides 37b, 38b, and 39a. Therefore, according to this embodiment, the straight line distance from the coil end carrier portion 35 to the corner P2 in the direction Z is greater than the straight line distance from the coil end carrier portion 35 to any other bottom side position.

This facilitates the insertion of the insert portion 29A made up of the three side walls 37, 38, and 39 into the slot 27 of the stator yoke 24. Therefore, the point P2 serves as the leading tip (apex point) of the insert portion 29A when it is inserted it into the slot 27. Moreover, the insert portion 29A of this embodiment can be made in the wedge shape having a pointed tip by simply sloping the bottom sides 38b and 39a of the side walls 38 and 39 because the meeting point of the sloped bottom sides serves as the insertion fore-end (peak P2). This facilitates design and manufacturing of the insert portion 29A itself.

It should be obvious from FIG. 6 that if the lower insert portion 29B has the shape of a mirror image of the upper portion 29A, the peaks P2 will be aligned with each other and the tapered portions will leave large gaps where the pole teeth facing surfaces will be uncovered, which is not desirable. Therefore a construction like that in FIG. 7 is employed where the peaks (P2 in this case) are not circumferentially aligned, but are staggered relative to each other.

As seen in this figure, insulating bobbin halves 28A and 28B are inserted in the same manner into the same slot 27 from above and under the stator yoke 24 with the distal ends of the two opposite insert portions 29A and 29B in the slot 27 of the third side walls 39 are spaced from each other through an inclined space indicated as d. The first side wall 37 and the second side wall 38 are opposite to each other spaced from each other on the radially outer side of the insert portion 29A and 29B by a distance of D. When the d is set to a specified constant value and the inclination angle of the bottom sides is set constant, the space d between the opposite surfaces B is maintained constant, while the distance between the surfaces A and C is up to a maximum of D. Therefore, the facing surfaces of the pole teeth are less exposed.

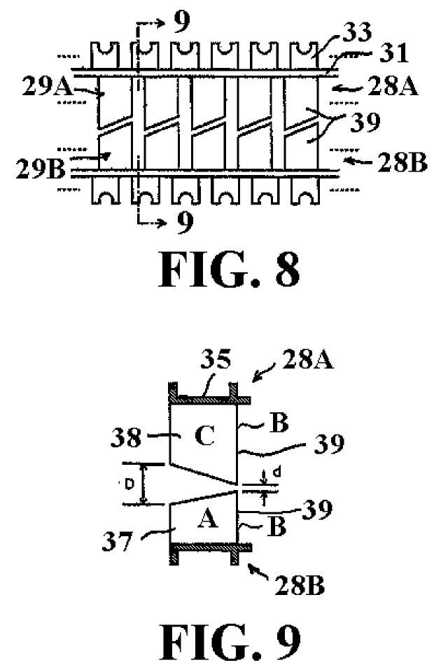

Referring now to FIGS. 8 and 9, these show how the insert portions 29A and 29B of two opposite insulators 28A and 28B appear respectively in developed circumferential and cross sectional views when received around a core (not shown). As is clear from these figures, the two opposite insert portions 29A and 29B meet through the distance at a minimum of d on the radially outermost side of the insert portions 29A and 29B and gradually increasing toward radially inner side up to a maximum of D.

Although the insulating bobbin halves 28A and 28B of the just described embodiment is designed with the insert portion as a whole in a wedge shape having a pointed tip at the peak P2, the tip of the insert portion according to this invention is not limited to the position P2. Any of other corners P1, P3, and P4 may also be made the tip of the insert portion by forming the bottom sides 81, 82, and 83 of the side walls 37, 38, and 39 with inclination. Moreover, the tip of the insert portion is not limited to the corners P1 through P4 but may be set in any point on the bottom sides 81, 82, and 83 of the side walls.

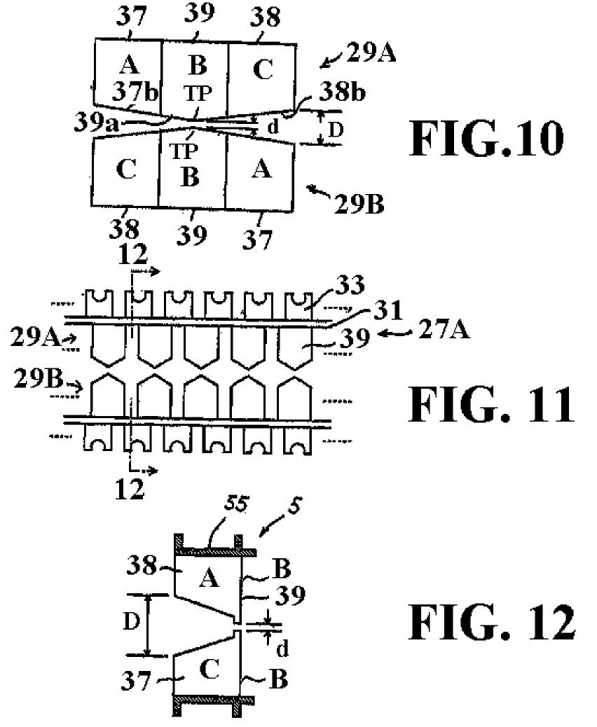

By way of an example of this, FIGS. 10, 11, and 12 show another embodiment in views corresponding respectively to FIGS. 7, 8, and 9 of the previously described embodiment. In this embodiment, the same or like components are identified by the same reference numerals. As may be seen, the insert portion tip TP is formed in the middle in the direction of width of the bottom side 83 of the interconnecting, third side wall 39. The outer sides 37b, 38b, and 39a of the side walls 37, 38, and 39 are sloped at a constant angle toward the tip TP in the developed view of FIG. 10.

Thus when the insulating bobbin halves 28A and 28B are inserted in the slots 27 of the stator yoke 24 (not shown), as illustrated in FIG. 10, the tips TP of the both third side walls 39 of the opposite insert portions 29A and 29B are spaced apart from each other through an inclined space indicated for example with d, and the first side wall 37 and the second side wall 38 opposite to each other are apart from each other on the radially outer side of the insert portion 29A and 29B by a distance of D which is slightly greater than D in FIGS. 7 and 9. Thus by positioning the insert portion tip TP in the approximate middle of the bottom side 39a of the third side wall the peaks of the insert portions 29A and 29B are positioned on the outside round surface side of the insulating bobbin halves 28A and 28B as in the previous embodiment. As a result, when a worker inserts the insert portions into the slots, it is possible to easily take aim at the slots and to insert them smoothly.

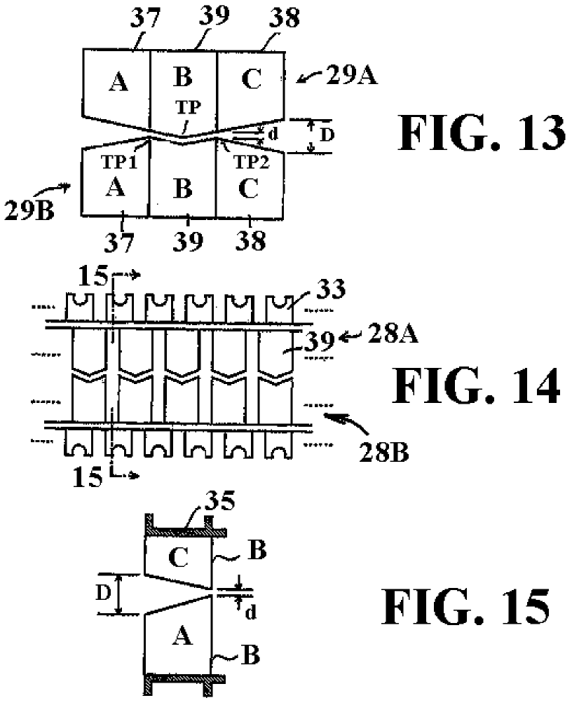

Referring now to FIGS. 13, 14, and 15, these show insulating bobbin halves in the final illustrated embodiment of this invention. In these figures the same or similar components as those in the foregoing embodiments are identified by the same reference numerals.

In this embodiment the upper insulator portion 29A and upper bobbin half 28A has exactly the same configuration of the like numbered embodiment of FIGS. 10-12. However the lower bobbin half, again identified by the same reference numeral 28B and its insulator portions 29B has two tips TP1 and TP2. The tip TP1 is formed where leading edge 37a of the first side wall 37 meets the leading edge 39a of the third side wall 39, and a meeting point TP2 where the bottom side 38a of the second side wall 38 meets the bottom side 393a of the third side wall 39. The bottom sides 37a, 38a, and 39a are inclined toward their tips TP1 and TP2. The bottom side 38a of the third side wall 39 is formed with a V-shape recess to be complementary to the contour of the bottom side 39a of the third side wall 39 of the insert portion 29A.

Thus in accordance with this embodiment, since the insert portion 29B has two tips TP1 and TP2, the insert portion as a whole is of an irregular wedge shape having two apexes, so that the ease of insertion into the slot 27 facilitated as with the previous embodiments. Thus with this embodiment it is possible that the distance d between the opposite third side walls 39 does not increase but remains constant and that the maximum distance D remains the same as the distance D in the embodiment of FIGS. 7-9, smaller than the corresponding distance D of the embodiment of FIGS. 10-12.

Thus from the foregoing description it should be readily apparent that the described and illustrated embodiments facilitate insertion of the insulators into attachment with the slots of the armature core while still maintaining good coverage of the core teeth. Of course those skilled in the art will readily understand that the described embodiments are only exemplary of forms that the invention may take and that various changes and modifications may be made without departing from the spirit and scope of the invention, as defined by the appended claims.

1. An insulator for the coil windings of an armature for a rotating electrical machine, the armature having a core having a cylindrical portion from which a plurality of circumferentially spaced teeth extend in a radial direction relative to the axis of relative rotation of the machine and defining slots therebetween, said insulator having a plurality of circumferentially spaced extensions having at least three sides, two of said sides being adapted to extend radially along the facing surfaces of adjacent of the teeth, the remaining of said sides comprising an interconnecting side extending between common peripheral ends of said two sides and adapted to be disposed at one end of the slot between the adjacent teeth, the projected ends of said sides tapering from at least one peak of the maximum length of said sides in the axial direction for facilitating fitting of said insulator into the armature in the slot in an axial direction.

2. An insulator as set forth in claim 1 wherein the number of insulator extensions is equal to the number of slots of the armature core.

3. An insulator as set forth in claim 1 wherein the plurality of extensions are integrally connected to each other by fourth sides that extend along one axial face of the pole teeth.

4. An insulator as set forth in claim 3 wherein, the number of insulator extensions is equal to the number of slots of the armature core.

5. An insulator as set forth in claim 1 wherein the at least one peak is formed at the point where one of the sides joins another of the sides.

6. An insulator as set forth in claim 5 wherein the one side comprises one of the facing sides and the third side.

7. An insulator as set forth in claim 1 wherein there are a pair of insulators as defined therein with the first, second and third sides thereof engaged between the same adjacent pole teeth and slots.

8. An insulator as set forth in claim 7 wherein the number of each of the insulator extensions is equal to the number of slots of the armature core.

9. An insulator as set forth in claim 8 wherein the plurality of extensions of each insulator are integrally connected to each other by fourth sides that extend opposite axial faces of the pole teeth.

10. An insulator as set forth in claim 9 wherein the peaks of the insulators are circumferentially spaced from each other to minimize the amount of the pole teeth that is uncovered.
